(19) United States
(12) Patent Application Publication
(10) Pub. No.: US 2010/0223845 A1
(43) Pub. Date: Sep. 9, 2010

(54) Aquatic plant stands

(76) Inventor: Bobbie F. Felling, Anaheim, CA (US)

Correspondence Address: STOUT, UXA, BUYAN & MULLINS LLP, 4 VENTURE, SUITE 300, IRVINE, CA, 92618, US

(21) Appl. No.: 12/658,944

(22) Filed: Feb. 16, 2010

Related U.S. Application Data
(63) Continuation-in-part of application No. 11/974,294, filed on Oct. 11, 2007, now abandoned.

(51) Int. Cl. A01G 1/00; F16M 11/24; A01G 9/02

(52) U.S. Cl. 47/66.7; 248/157; 47/58.1 R

(57) ABSTRACT

The present invention is draft to corrosion resistant aquatic plant stands, planters, and aquatic animal stands comprising a platform assembly, for use in a shallow body of water. In a preferred embodiment, the length and/or the angle of the legs of the stands of the present invention are adjustable, particularly preferably independently adjustable to permit the platform assembly to be stably and substantially horizontally oriented in use, despite irregularities on the bottom of the body of water.

### FIELD OF THE INVENTION

The present invention is directed to compositions and methods related to aquatic plant stands, planters and flora and fauna supports. In particularly preferred embodiments, the planters, platforms, and stands of the present invention are structured to be used in ponds, such as koi and other ornamental fish ponds to support aquatic plants and fauna such as turtles and frogs.

### BACKGROUND OF THE INVENTION

Conventional water ponds and water gardens are typically made by digging a hole into the ground to a depth of approximately 18 to 36 inches or more to accommodate various plants and in some cases ornamental fish, and amphibious animals such as turtles and frogs. In some pond installations, one or more shelves may be formed in the side wall of the excavation for supporting particular types of water plants which are planted in pots. Additionally, some plants may be planted directly on the bottom of the pond excavation. Various varieties of plants contained in pots may be placed on the bottom of the pond and on the shelf. Common type of plants used in water ponds and water gardens include deep water plants and marginal plants or bog plants. Deep water plants such as water lilies are generally placed 8 to 36 inches or more below the water. These types of plants grow from a tuber and form an elongate plant that extends well above the water surface.

In other pond installations, the excavation does not include the shelf formed in the side wall. While some types of plants contained in pots may be placed on the bottom of the pond excavation, it may be necessary to support those that require a more shallow depth by any means at hand. Commonly, bricks, boards, cinder blocks, or milk crates are placed on the bottom of the tub and may be stacked to achieve the recommended depth.

Tropical lilies may be planted for example 12 to 20 inches below the surface of the water. Bog plants such as cattails, horsetails, and rushes live in the shallows of the pond and their pots may be placed 8 to 16 inches below the water. They are commonly supported on stacked bricks, boards, cinder blocks, or milk crates to achieve the recommended depth. These type of plants may grow anywhere from a foot to about 8 feet and thus also extend well above the water surface.

When water plants are planted in pots, often the soil is terminated about 2 inches from the top of the pot and the top of the soil is covered with an approximately 1″ layer of stones or gravel to prevent the soil from floating and to prevent fish from digging into the soil.

Because these upper portions of these types of water plants extend well above surface of the water and the pots in which they are planted are at a relatively shallow distance below the water surface, they may frequently blow over or slide off the support shelf or supporting bricks, boards, cinder blocks, or milk crates. This also causes the stones and gravel to spill into the pond and/or the potting soil to become dislodged and float in the water. Thus, the caretaker must often wade into the water to place the plants back into the upright position, and to retrieve the stones and gravel. Sometimes it is necessary to repot the plant.

Normal pond maintenance includes periodic cleaning of the bottom and sides of the pond. Because pots set directly on the bottom or sides of the pond tend to become covered with sediment over time, the pots must be removed (requiring the gardener to wade into the pond and remove and separately clean the pots and the bottom of the pond), or the pond will be cleaned with the pots in place, thus leading to an incomplete and unsatisfactory cleaning job.

Additionally, if the plants have grown substantially after initial planting, removal of the pots will require trimming and thinning of the plants, and/or the coordination of more than one person to prevent damage to the plants during the removal process.

The use of bricks, stones, boards, cinder blocks, milk crates, and other supports and stands do not permit acceptable or efficient “in place” cleaning of the pond bottom or stands. Metal plant stands also tend to corrode quickly after placement in the pond, since they are not intended for use while immersed in water.

Additionally, plant stands having legs are generally particularly unstable when placed on an uneven, rocky surface such as the bottom of a pond. This is also true when a plant stand is placed on the bottom of a pond near the edge, where the side of the pond bank slopes upward while the portion of the pond bottom extending away from the pond bottom, is more nearly level, although rarely perfectly so.

Howell, U.S. Pat. No. 5,050,339 discloses a plant stand for nursery shrubs having a larger base ring and a vertically spaced smaller ring which prevents the plant from tipping over in strong winds. However, there is no provision nor suggestion of any means for placing a potted plant a selected distance beneath a water surface.

Glamos, U.S. Pat. No. 5,174,060 discloses a plant stand having metal rod legs which are driven into the ground and encircled by helically coiled wire with a circular ring at each end. However, this stand is narrower at the bottom than at the top and there is no provision nor suggestion of any means for placing a potted plant a selected distance beneath a water surface.

Hillestad, U.S. Pat. No. 5,179,799 discloses a demountable tomato plant stand having metal rods which are driven into the ground and a plurality of vertically spaced circular rings. However, this stand is narrower at the bottom than at the top and there is no provision nor suggestion of any means for placing a potted plant a selected distance beneath a water surface.

Wourms et al., U.S. Pat. No. 6,119,393, is directed to ringed supports for suspending a plant pot in water. The support has at least one horizontal circular pot receiving ring member configured to encircle a pot containing a potted plant and support it in an upright position adjacent to a surface of the enclosure at a selected depth beneath the top surface of the body of water.

### SUMMARY OF THE INVENTION

The present invention is drawn in part to methods and compositions concerning maintaining aquatic plants in a body of water at a desired distance below the surface of the water. Unlike the methods of placing plant pots on the pond bottom described above, in one embodiment the present methods and compositions involve the use of a plant stand having a plurality of legs of adjustable length. In particularly preferred embodiments legs of the plant stands of the present invention are separately and independently adjustable, thus permitting each leg to be a different length, in order to more effectively maintain the plant stand in a substantially horizontal orientation parallel to the water surface.

As used in this patent application “plant stand” means a stable stand with a substantially horizontal surface structured to support one or more aquatic plant (preferably fresh water, presently less preferably, salt water), or to support one or more turtle, bird, or other animal living in an aquatic environment.

In other particularly preferred embodiments, the legs of the plant stand are weighted to be stable when immersed in water, for example, to prevent the plant stand from becoming unstable, both despite the buoyancy of water (for example, and without limitation, when the stand is located in a water current such as that caused by a circulating pump) or when the plant stand is jostled by fish, turtles, birds, or other animals living in an aquatic environment.

Thus, in one preferred embodiment, the present invention includes plant stands that are heavy or weighted and do not float in water, are heavy and/or weighted and therefore structured to resist tipping over easily, or both. The invention also includes methods of making and using such plant stands. In a specific embodiment a plant stand of the present invention may be structured to have more weight in the lower half of plant stand than in the top half of the plant stand. For example, the ratio of weight (in air) of the bottom half of the plant stand to the weight of the top of the plant stand may be 1.5:1, or about 2:1, or about 2.5:1, or about 3:1, or about 3.5:1, or about 4:1, or about 4.5:1, or about 5:1 or about 6:1, or about 7:1 or about 8:1 or about 10:1 or greater. The added weight may be the result of different materials used in the lower half of the plant stand than in the upper half of the plant stand. For example (without limitation), the top half of the plant stand may be structured using mainly hollow metal tubing, plastic, or a lighter metal such as aluminum, while the lower half of the plant stand may be partly, largely, or completely made using solid metal, or a heavier or more dense metal or other material. In one preferred embodiment the insert portion of a plurality of the extendable legs of the plant stand are made of a solid material, such as stainless steel, in order to add weight to the bottom half of the plant stand. In an alternative embodiment, the plant stand may have weights fastened to the structure thereof, such as “lead doughnut” moldable type weights, or weights directly attached to the fame of the stand itself.

In another embodiment, the present invention includes plant stands that are lightweight or can be easily transported or can float in water, and methods of making and using such plant stands. In certain preferred embodiments, the angle and/or length of a plurality of the legs of the plant stand can be independently adjusted to provide at least one of: a) increased stability to the plant stand, or b) the ability to effectively maintain the plant- or animal-supporting surface of the stand in a substantially parallel orientation to the water surface, particularly when the legs of the plant stand are placed on an uneven surface.

The plant stands of the present invention are preferably made of a plastic or metallic material that is sufficiently stable and corrosion-resistant to have a useful lifetime measured in years rather than months. If the material is a metal, the plant stand may be made of zinc or a zinc alloy, or it may be galvanized or otherwise coated with zinc or another material having low corrosion potential. By “galvanized” means coated with zinc or a Zinc alloy. Commonly, galvanization involves treating a metal with a caustic acid solution to remove any deposited organic material, and in hydrochloric acid or sulfuric acid to remove mill scale and/or rust. The metal is then bathed in a flux which promotes the chemical bonding of steel and zinc. Once the metal has been cleaned in this fashion, it may be “hot dip” galvanized, whereby the metal is bathed in molten zinc, and the surface of the metal forms zinc-iron intermediate layers and a pure zinc outer layer. Alternatively, the plant stand may be made of a metallic material over which a layer or sheath of corrosion resistant material such as, for example, plastic, or appropriate thickness fits snugly or is coated on.

The corrosion of metals in water is largely controlled by the impurities present in the water. Naturally occurring waters are seldom pure. Even rainwater, which is distilled by nature, contains nitrogen, oxygen, CO₂, and other gases, as well as entrained dust and smoke particles. Water that runs over the ground carries with it eroded soil, decaying vegetation, living microorganisms, dissolved salts, and colloidal and suspended matter. Water that seeps through soil contains dissolved CO₂ and becomes acidic. Groundwater also contains salts of calcium, magnesium, iron, and manganese. Seawater contains many of these salts in addition to its high NaCl content.

All of these foreign substances in natural waters may affect the structure and composition of the resulting coating films and corrosion products on the surface of a metal (including a galvanized or zinc object), which in turn control the rate of corrosion of the metal. In addition to these substances, such factors as pH, time of exposure, temperature, motion, and fluid agitation influence the aqueous corrosion of zinc. However zinc has a low corrosion potential compared to many other metals.

In certain embodiments, the plant stands of the present invention (which term, unless clearly indicated otherwise herein, shall be deemed to include planters and amphibian stands) have three legs; these legs have adjustable lengths to set the desired depth under the surface of the pond at which the plant is to be grown. In other embodiments the stands may have four or more legs. In particularly preferred embodiments, the legs of the plant stands of the present invention are independently adjustable in length.

The plant stands of the present invention may be made of any suitable corrosion-resistant material. Preferably the device is made of a durable polymeric material, such as polycarbonate, polypropylene, a thick vinyl or polyvinyl chloride or the like, or a corrosion-resistant metallic material, such as a stainless steel, galvanized iron or steel, zinc, bronze and the like.

Although the plant stands of the present invention may be made using material having cross sections of any shape, often one or more section will have a polygonal cross-section, such as rectangular leg and/or center post sections, in a preferred embodiment one or more section is made of hollow metal tubing. The hollow tubing is preferably made in an insert component/sheath component configuration so as to allow the leg assemblies and/or center post (if applicable) to be slidably adjustable. In accordance with the desire for the plant stands to be sufficiently heavy to resist movement in the water, certain components may be chosen to be made of heavier or solid tubing. For example, the inserts of the insert component/sheath component configuration discussed above for use in the legs may be made to be solid rather than hollow to increase the weight of the stand (for example making the plant stand more “bottom-heavy”).

Alternatively, the length of the legs may be made adjustable by any other method, such as folding leg segments (such as hinged leg segments) or the like.

By “sheath” and “insert” is meant that a sheath component section comprises a hollow, straight (or more rarely, smoothly curved) segment of elongated material having at least one open end and an inner shape, circumference or perimeter only slightly larger than the outer shape, perimeter or circumference of the “insert”. The insert has the same or a similar cross-sectional shape as the sheath, is smaller than the sheath, and structured to wholly or partly slidably fit inside the sheath. The insert may or may not be hollow. In a preferred embodiment, the insert is solid, and has a substantial weight. For example, the insert may be made of a heavier material than the sheath, or than the materials used in other parts of the plant stand in order to increase the stability and weight of the plant stand in use.

The sheath and/or insert components may be made by any suitable method. For example, the sheath and/or insert may be molded or cast from a metal or polymeric material. The sheath or insert component may be made using a wire-like material that is first wound and then welded, soldered or cooled to form the sheath or insert component.

As described elsewhere herein, the legs of the plant stand may be weighted or otherwise made to be heavy to be stable, for example, against the movement of aquatic animals and the buoyancy of all materials in water. In a preferred embodiment, the weighting of the legs may be achieved, for example, by a solid insert component when the leg assembly is in a sheath and insert component configuration to provide for the length adjustable feature of the leg assemblies. The solid insert component may be comprised either partially or substantially entirely of a metal or metal alloy such as, for example, stainless steel, galvanized iron or steel, zinc, bronze and the like. In certain embodiments the solid insert component may include, for example, a snugly fitting or coating cover of tough, corrosion resistant material such as plastic, of appropriate thickness, to create a snug fit and to resist corrosion. In a preferred embodiment, the weight of all the solid leg insert components put together may constitute (without limitation) from about 20% to about 90% or more of the weight of the entire plant stand, or about 25% to about 50% of the weight of the entire stand, or about 25% to about 33% by weight of the entire stand. This may result in the plant stand having a ratio of weight (in air) of the bottom half of the plant stand to the weight of the top of the plant stand of about 1.5:1, or about 2:1, or about 2.5:1, or about 3:1, or about 3.5:1, or about 4:1, or about 4.5:1, or about 5:1 or about 6:1, or about 7:1 or about 8:1 or about 9:1 or about 10:1 or greater.

As described elsewhere herein, in one embodiment, the angle of each of the leg assemblies to the center post assembly can be adjusted, between 0° and 90° (and specifically and individually including each and every angle in between these angles) to provide at least one of: a) increased stability to the plant stand or b) ability to effectively maintain the plant stand in a substantially parallel orientation to the water surface, particularly when the legs of the plant stand are placed on an uneven surface. As will be evident to a person of ordinary skill in the art the angle of the leg assemblies may be adjusting by any of several mechanisms, all of which are hereby incorporated as part of this invention.

Thus, in one example, a plurality of the leg assemblies may be joined or linked or connected to the center post assembly via continuous angle adjustable wherein each of the legs are fixed at desired angles with the help, for example, a thumb screw.

Other ways can be used to secure the adjustable parts of the plant stands of the present invention, in another preferred embodiment, the insert and sheath section(s) of one or more structural segments of the plant stand may be perforated lengthwise by s series of holes, for example, in a set of substantially evenly spaced circumferentially opposing columns of holes. In this way, a bolt may be extended through a hole of the sheath portion, through the corresponding holes of the insert section within, and out through the opposing hole of the sheath section to secure the length of the structural segment. However, in another embodiment the sheath has a screw, such as a thumb screw, located on its outer surface and the screw may be tightened against the insert when the segment is at its desired length. In this latter embodiment, the insert may lack holes.

Alternatively, the insert component may be manufactured with springing projections that protrude through holes in the sheath component when aligned therewith, thus locking the length of the combined sheath and insert components. Thus, in this embodiment the insert may not have holes, and a separate locking pin or bolt is not needed.

Both insert component and sheath component may independently be made of any corrosion-resistant material having enough structural integrity to support the desired plant or plants thereupon. Thus, the insert and/or sheath components may be substantially solid or contain perforations; such perforations, which may aid in reducing the weight of the stands, may be in addition to any holes placed in the components for securing purposes as described above.

In a preferred embodiment the top-facing surface of the plant stands of the present invention are comprised of a grating or sieve-like platform. For example, if made of metal, the top-facing platform may be made of a wire mesh or an expanded metal. An expanded metal is a sheet metal that has been slit and then stretched to up to 10 times its original width. Expanded metal (and to a somewhat lesser degree, wire mesh) has the advantage of being lightweight, strong, and permits light, water and silt to pass through the surface. Thus, sediment or soil spillage on the platform top will naturally fall through the platform to the pond bottom. Additionally the lightweight feature permits the distribution of the bulk of the weight to the bottom of the stand. In alternative embodiments a similarly shaped polymeric material may be used.

The platform may be used as a surface for placing a container containing the plant and soil upon. Alternatively, the plant may be planted directly on the platform; that is, the platform itself may comprise an integrated planter. In this case it may be desirable to first place a layer of moss, gravel or other similar material on the platform surface before adding the plant soil in order to facilitate retention of the soil on the platform.

In preferred embodiments the top-facing platform is recessed by 12 to 6 inches or more, preferably about 4 inches, being at least partly surrounded by upward extending side walls around the perimeter or circumference of the platform. Generally, the platform assembly (comprising the platform itself and the side walls) is rectangular; however in less preferred embodiments the platform shape may be oval, circular, or otherwise non-rectangular. The side walls are configured to facilitate the retention of soil and plant or a pot on the platform surface.

In other embodiments, for example (but not exclusively) in the amphibian stands of the present invention, the top-facing platform assembly may not comprise side walls. In these embodiments the platform is placed at a height above the water's surface as a sunning surface. The platform assembly may have an additional “ramp” feature comprising an additional substantially flat surface extending at an angle downward from the platform to, or slightly above or below the water surface. Additionally, in this embodiment the platform and/or ramp may be advantageously covered with a material, such as an artificial turf material, to facilitate traction and conform for frogs, salamanders and turtles to walk upon.

In certain embodiments the plant stands of the present invention may comprise four or more legs. For example, in one preferred embodiment the legs of the invention may comprise four independently adjustable legs. In this embodiment the legs may be placed at the corners of a platform, as described above. The legs of the plant stand are substantially vertically disposed, so as to form a table-like structure. Each leg is made of one insert and one sheath of tubing. In a particularly preferred embodiment the sheath component is solid and each segment (insert and sheath) is approximately 6½ inches in length and has holes disposed about 1½ inch from the bottom and about 1½ inches from the platform, the holes being spaced approximately 2 inches apart. Of course, the exact spacing of the holes from each other may not be critical in this embodiment of the invention; generally holes spaced from about 1 to about 3 inches apart are particularly useful so as to enable the plant stand to be as useful for as many types of plants as possible.

In certain embodiments, the plant stands of the present invention may be between about 10 pounds and about 100 pounds or more, or between about 20 pounds to about 80 pounds, or about 30 to about 60 pounds in weight. As described elsewhere herein, in the embodiments where the leg assemblies are independently height adjustable and comprise and sheath and insert component, the leg assemblies, or alternatively, all the insert components may constitute from about 20% to about 90% of the weight of the entire plant stand, or about 25% to about 50% of the weight of the entire stand, or about 25% to about 33% by weight of the entire stand.

Pond plants may include fully submerged plants such as Anacharis, Cambomba, Hornwort, Red Ludwigia, Vallisneria; water lilies (which may include hardy lilies and tropical lilies), lotuses, and bog plants such as arrowheads, cattails, grasses and reeds, rushes, cannas, papyrus and palms, taro, and various flowering plants.

The plant and animal stands of the present invention may be manufactured and/or adjusted to hold plants at a variety of heights above the pond bottom. For example, an animal stand may be made using a 20 inch section of tubing as a sheath and another 20 inch section of tubing as an insert, both directed to a center post of a three-legged plant stand. The legs of the stand may extend may extend below the lowest part of the center post by a few inches, and are independently extendable by an additional 2 or three inches. Furthermore, the platform may have an intrinsic height; this the total height of this particular stand may exceed 40 inches.

In other embodiments, a plant stand may be about 8 or about 12 inches high, or about 18 or about 24 inches high, or about 30 or about 36 inches, or about 42 or about 48 inches high when each adjustable part of the stand is at its approximate midpoint.

### BRIEF DESCRIPTION OF THE DRAWINGS

FIG. 1A shows a view of a platform assembly according to an embodiment of the present invention.

FIG. 1B shows a view of a three-legged pond stand according to an embodiment of the present invention.

FIG. 2A shows a view of a platform assembly according to a different embodiment of the present invention.

FIG. 2B shows a view of a three-legged pond stand according to a different embodiment of the present invention.

FIGS. 3A and 3B show, respectively, the platform apparatus and side view of a four legged pond stand according to an embodiment of the present invention.

FIG. 4 shows an aquatic animal platform of an embodiment of the present invention.

FIG. 5 shows two stands in use with individually adjustable legs according to an embodiment of the present invention. The first stand is a plant stand, while the second stand has a platform for aquatic animals extending above the water surface.

FIG. 6 shows an embodiment of the present invention, showing the legs of a plant stand, which comprise a hollow sheath component and a solid weighted insert component.

### DETAILED DESCRIPTION OF THE PREFERRED EMBODIMENTS

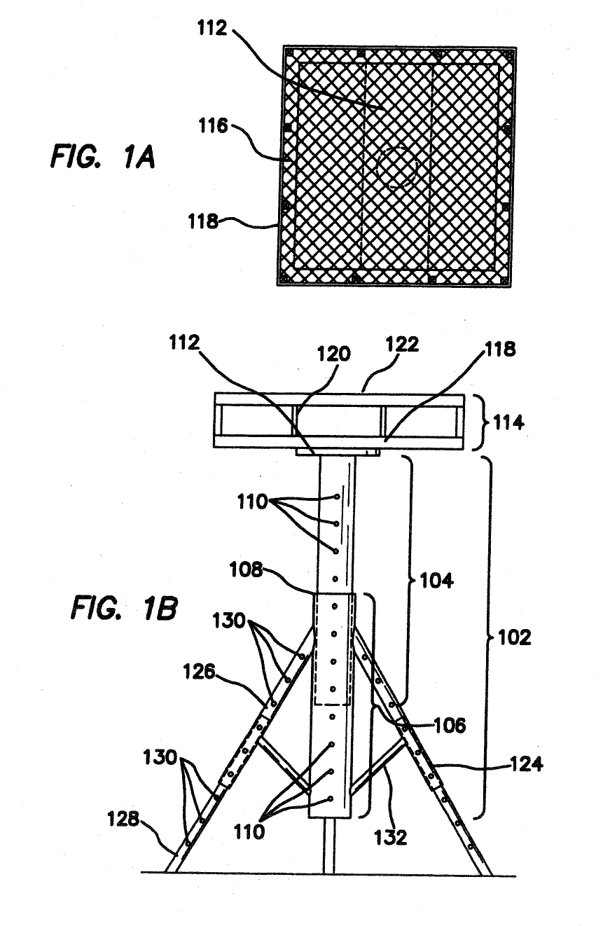

Turning now to FIG. 1B, an embodiment of the plant stand of the present invention is shown. The plant stand is made using corrosion-resistant metallic components comprising a center post (102) which itself comprises an insert component (104) comprising the upper portion of the center post and a sheath component (106) comprising the lower portion of the center post. In this embodiment the corrosion-resistant metallic components comprise galvanized steel. The sheath component is made using hollow 3 inch exterior diameter tubing having an interior diameter of 2 6/8 inches. The insert component has an external diameter of 2½ inches, thus permitting it to slide inside the open bore (108) of the sheath component. Each of the insert component and the sheath component are provided with a longitudinal row of holes (110), evenly spaced 2 inches from each other and extending through diametrically opposing sides of the insert component and the sheath component to permit a bolt or pin to be inserted through corresponding holes in these components in order to secure the slidably adjusting center post at the desired height. It will be appreciated that in other, alternative embodiments the holes only need extend through a single wall of each the insert and sheath components.

The center post insert component is joined to a rectangular plate (112) which supports and is part of the plant stand platform assembly (114). In the embodiment of FIGS. 1A and 1B, the bottom of the platform is comprised of a square 1″×1″×⅛″ sheet of galvanized steel (116) which is fastened to the rectangular plate (112). This sheet may be fabricated, welded, cast, or otherwise formed in an L shape, thus providing a side wall perimeter (118) also having the dimensions 1″×1″×⅛″ to form a frame. Alternatively, two separate 1″×1″×⅛″ sheets may be placed in conjunction with each other or joined to make this square, lipped platform frame component. Of course, those of ordinary skill in the art will immediately see that the platform need not be square in shape and may have a polygonal, oval, circular, or other shape; in this event the plate and sheets will be formed in conformity with the shape decided upon.

An open side wall is created using vertically extending members (120) connected to another 1″×1″×⅛″ galvanized steel sheet (122). The vertically extending members in this embodiment are inch square tubing segments 2 inches long and joined at or near the bottom to the frame component and at or near their top surface to the 1″×1″×⅛″ galvanized steel sheet (122) by any suitably strong means, such as by welding, bolting or screwing or otherwise fastening. There are vertically extending segment components at each corner of the platform assembly and two additional segment components equally spaced from each other and from the corner segment components along each edge of the platform. The person of ordinary skill in the art will recognize that the platform may alternatively be made of a dissimilar material from the remainder of the plant stand, such as a wood, a polymer, or a different corrosion resistant metal or metal alloy. Furthermore, the platform need not have side walls, or may have closed, higher, or lower side walls and greater or fewer vertically extending segment components than in the embodiment shown in FIGS. 1A and 1B.

The sheath component of the center post shown in FIG. 1B is joined to three leg assemblies spaced radially approximately 120 degrees from each other (124). In the embodiment shown, the leg assemblies each comprise a sheath component (126) and are made using 1″ round tubing. The insert component (128) is also made using round tubing; the outer diameter of the insert tubing is slightly smaller than the inner diameter of the sheath tubing so as to be capable of sliding within the sheath component. The tubing for both sheath and insert is galvanized steel. As with the center post, each sheath and insert includes a row of holes (130) preferably evenly spaced along their length. Importantly, the spacing of the holes should be substantially identical for each sheath and each insert. The leg assemblies (124) are joined to the center post at substantially identical heights by any suitable means, and extend obliquely groundward from the center post at substantially identical angles. Joining means may comprise bolting, screwing, welding, by way of a hinge, or any other suitably stable and strong means of fastening. In the embodiment shown, the sheath component of the leg assembly is joined to the sheath component of the center post. However, in less preferred embodiments the insert section may be joined to the center post.

Each leg assembly is supported with an upward angled strut support (132) made from inch tubing, one end portion of which is joined to the bottom portion of the sheath component of the center post and the upper portion of which is joined to the sheath component of the leg assembly. The strut may be fixed to the center post by bolting, screwing, welding, by way of a hinge, or any other suitably stable and strong means of fastening. Preferably the bottom of each leg assembly is cut so as to make full contact with a level surface.

As shown in FIG. 1B, the length of each leg assembly is independently adjustable by sliding the insert component within the sheath component and then securing the insert in place using, for example, a bolt, pin, thumb screw, or any other suitable means of securing. The holes in the insert and sheath may be aligned to permit a bolt or pin to be placed through the walls of each, thus securing the length of the leg. Independent leg assembly adjustment is particularly useful when the pond bottom is uneven, or when a plant stand is placed close to the pond bank, where the leg closest to the side of the pond may require shortening to ensure the platform is approximately level.

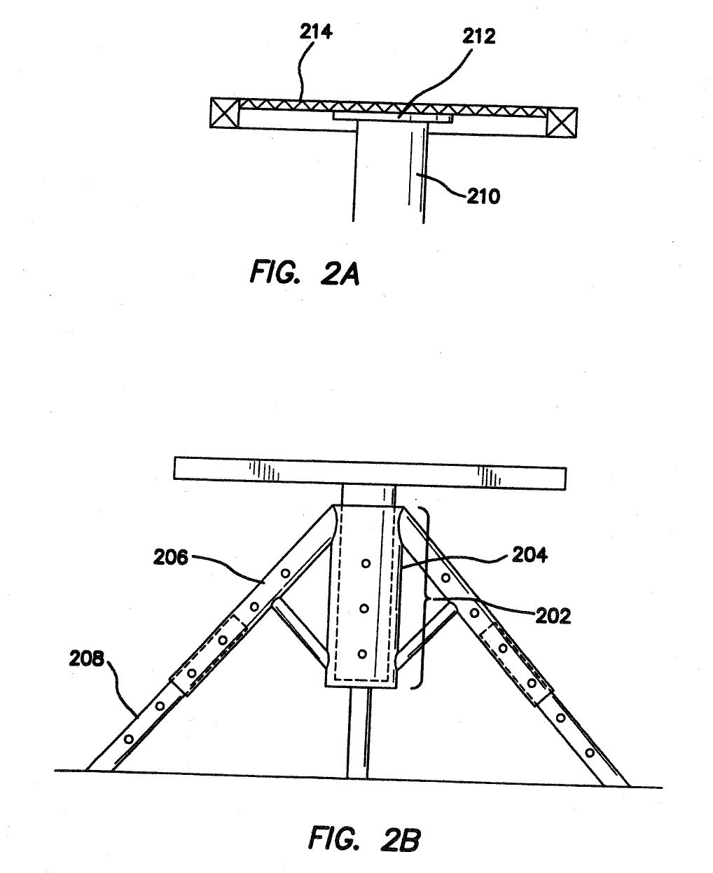

FIGS. 2A and 2B shows a similar plant stand to the one shown in FIGS. 1A and 1B; however this plant stand is not made to extend as high as the previous embodiment. Essentially, the features of the plant stand of FIG. 2B are substantially identical to those shown in FIG. 1B, but the sheath component of the center post (202) is 8 inches long, and the insert component (204) is only slightly longer. Similarly, the three leg assemblies comprise shorter sheath (206) and insert (208) components than the taller stand of FIG. 1B as well.

FIG. 2A shows another embodiment of the platform component of the plant stand of the present invention. Thus, in this embodiment the upper portion of the center post insert component (210) is joined to a rectangular plate (212), upon which is supported the top surface component of the platform (214), which in this embodiment is a wire mesh, expanded metal or other grated surface. The top surface component is joined to a frame comprising 1″ square galvanized steel; the rectangular plate (212) is joined directly to the grating or to a frame element. Joining may be accomplished by any means suitable to hold the platform to the remainder of the plant stand—examples of suitable joining methods may include welding, casting, bolting, screwing, fastening and the like.

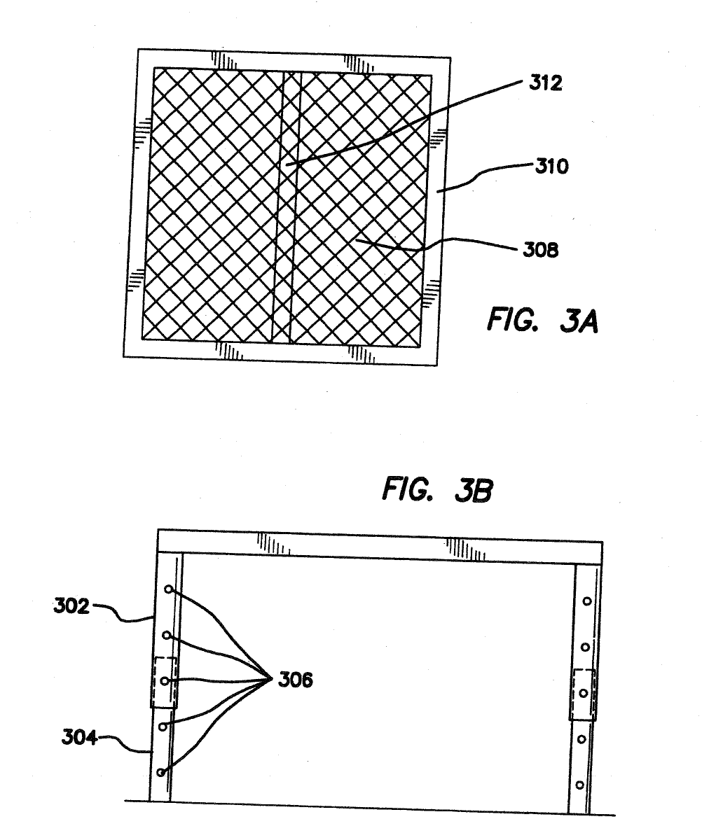

FIG. 3A and FIG. 3B show another embodiment of the present invention in which the stand has four leg assemblies. In this embodiment the leg assemblies each comprise a sheath component (302) and an insert component (304). Each of these elements are about 6½ inches in length and made of a corrosion resistant metal, such as zinc. Each of the sheath and insert comprise a row of holes (306) evenly spaced about 2 inches from each other along the length of each component. Preferably, the holes extend through diametrically opposed sheath and/or insert component walls. In this embodiment, each insert component is capable of sliding within the sheath until the desired length is obtained, and then a pin or a bolt may be placed through the holes of sheath and insert components to lock them together at such desired length.

The leg assemblies extend substantially vertically and join the platform assembly at each of its four corners. The leg assemblies may be joined by any suitable means, including without limitation, welding, casting, bolting, screwing, fastening and the like to the platform assembly.

The platform assembly comprises a top surface component (308) which may be comprised of, for example, wire mesh, expanded metal or a similar grated surface. As in FIGS. 2A and 2B, the top surface component is joined to a frame comprising 1″ square galvanized steel (310). In this embodiment a supporting bar (312) is placed below the top surface component and joined directly to a frame element.

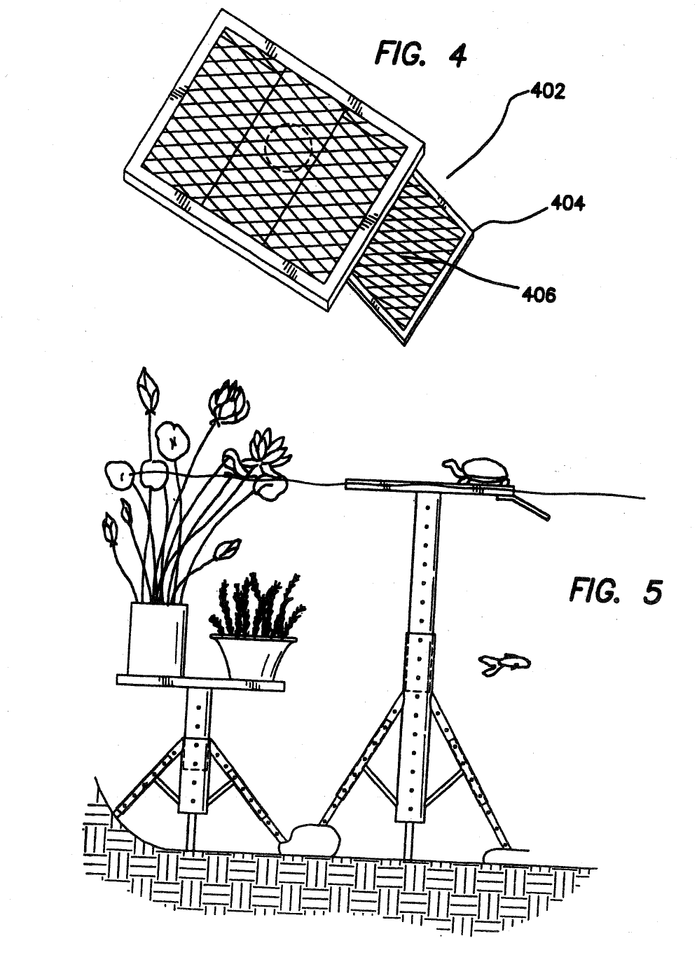

FIG. 4 shows an alternative platform assembly, this one for an amphibian stand. This platform is designed to project from the surface of the water; optimal distances above the water are from about ½ inch to about 4 inches, or about 1 inch to about 3 inches or about 2 inches. The main platform assembly is substantially identical to the platform shown in FIG. 2A. However, a “ramp” feature is joined to one or more edge of the platform at an angle leading substantially to or below the water's surface. The ramp (402) comprises an additional substantially flat surface (406), such as a grated surface, framed by a corrosion resistant material such as ½ inch tubing (404), which is joined to the larger main platform, generally at the underside of the frame of the larger platform assembly.

Additionally, in this embodiment the amphibian platform and/or ramp may be advantageously covered with a material, such as an artificial turf material, to facilitate traction and comfort for frogs, salamanders and turtles to walk upon.

It will be understood that when the present invention is used as an amphibian platform, the stand must be long enough to extend from the bottom of the pond to the surface of the water. Accordingly, either or both the leg assemblies and the center post assemblies (if, for example, in a tripod configuration) must be long enough to raise the platform above the water level. Otherwise the amphibian platform may be essentially identical to the plant stands of the present invention except for the addition of the platform assembly ramp and platform surface covering, if present.

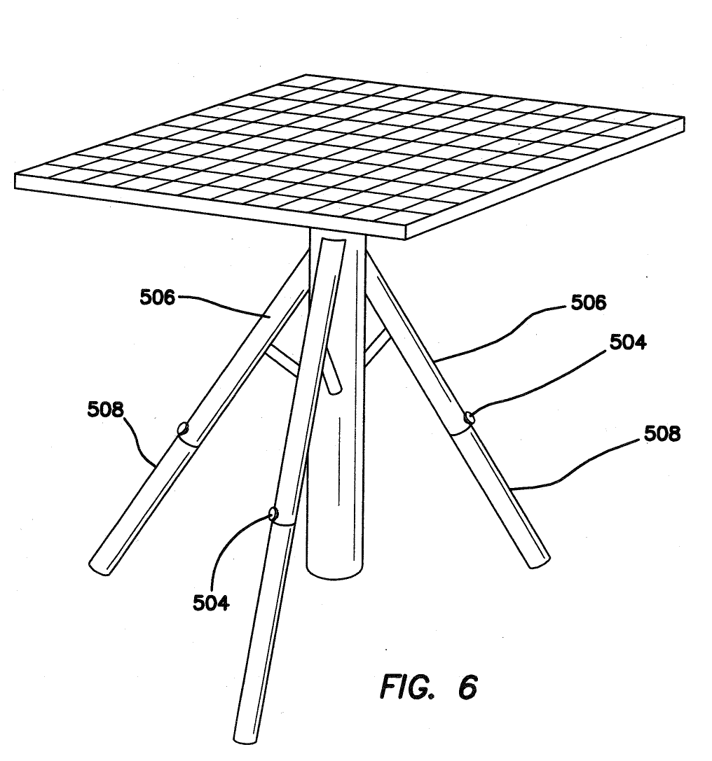

FIG. 6 shows an embodiment of the present invention, in which the legs of the plant stand comprise a hollow sheath component made of metal tubing (506) and a solid metallic insert component (508), whereby the length of each leg is independently adjustable using a set screw (504). The solid metallic insert component adds weight at the bottom of the plant stand thereby preventing the stand from being toppled when in use.

The claims that follow this specification define the invention, which shall not be considered limited to the embodiments explicitly exemplified herein. Although the foregoing invention has been described in detail for purposes of clarity of understanding, it will be obvious that certain modifications may be practiced within the scope of the appended claims.

I claim:

1. An immersible corrosion-resistant apparatus comprising:
a platform assembly suitable for supporting aquatic plants or animals;
at least three leg assemblies, wherein the length of each of the leg assemblies is independently adjustable thereby permitting the platform assembly to be approximately level on an uneven surface, and wherein
each leg assembly comprises a first sheath component and an first insert component slidably located at least partially within said sheath component whereby the length of said leg assembly is adjustable by sliding the first insert component within the first sheath component, and wherein each first insert component is solid.

2. The apparatus of claim 1 comprising a substantially vertically oriented center post assembly to which said leg assemblies are joined, said center post assembly including a second sheath component and a second insert component slidably located at least partially within said second sheath component whereby the length of said center post assembly is adjustable by sliding the second insert component within the second sheath component.

3. The apparatus of claim 1 wherein the combined weight of all the first insert component is between about 25% to about 50% of the weight of the entire plant stand.

4. The apparatus of claim 2 wherein the platform assembly is directly or indirectly joined to the upper portion of the center post assembly, said platform assembly comprising a substantially horizontal top surface and a frame component surrounding the top surface, said frame component comprised of a corrosion-resistant material.

5. The apparatus of claim 1 wherein said apparatus comprises a corrosion-resistant material selected from the group consisting of a polymeric material, a metal or a metal alloy.

6. The apparatus of claim 5 wherein said corrosion resistant material comprises a metal or metal alloy having at least a surface coating of zinc or a zinc-containing alloy.

7. The apparatus of claim 1 wherein each of the leg assemblies are joined to the center post assembly in a manner such that the angles of each of the leg assemblies to the center post assembly are independently adjustable.

8. A method of growing plants under the surface of a body of water comprising:
placing an aquatic plant on a substantially horizontal platform of a corrosion-resistant plant stand apparatus, wherein said platform is located under the surface of a body of water and sufficiently close to said surface to permit said plant to receive sufficient light through said body of water for growth of said plant, said apparatus comprising a platform assembly suitable for aquatic plant or animals, at least three leg assemblies, wherein
the length of each of the leg assemblies is independently adjustable thereby permitting the platform assembly to be approximately level on an uneven surface and wherein
each leg assembly comprises a first sheath component and an first insert component slidably located at least partially within said sheath component whereby the length of said leg assembly is adjustable by sliding the first insert component within the first sheath component and wherein
the first insert component is solid.

9. The method of claim 8 wherein the apparatus comprises a substantially vertically oriented center post assembly to which said leg assemblies are joined, said center post assembly including a second sheath component and a second insert component slidably located at least partially within said second sheath component whereby the length of said center post assembly is adjustable by sliding the second insert component within the second sheath component.

10. The method of claim 8 wherein said plant is located in a pot containing soil, and wherein the pot is located on the top surface of the platform assembly of said apparatus.

11. The method of claim 8 wherein said apparatus comprises a corrosion-resistant material selected from the group consisting of a polymeric material, a metal or a metal alloy.

12. The method of claim 8 wherein said corrosion resistant material comprises a metal or metal alloy having at least a surface coating of zinc or a zinc-containing alloy.

13. The method of claim 8 wherein said apparatus comprises
a platform assembly including four or more leg assemblies, wherein the length of said leg assemblies is independently adjustable thereby permitting the platform assembly to be approximately level on an uneven surface, the legs are substantially vertically disposed and each said leg assembly comprises a sheath component and an insert component slidably located at least partially within said sheath component whereby the length of said leg assembly is adjustable by sliding the insert component within the sheath component and wherein the insert component is solid.

14. An immersible corrosion-resistant apparatus comprising:
a platform assembly suitable for supporting aquatic plants or animals; and
four or more leg assemblies wherein, the length of each of the leg assemblies is independently adjustable thereby permitting the platform assembly to be approximately level on an uneven surface, the legs are substantially vertically disposed and each said leg assembly comprises a sheath component and an insert component slidably located at least partially within said sheath component whereby the length of said leg assembly is adjustable by sliding the insert component within the sheath component and wherein the insert component is solid.
